(19) United States
(12) Patent Application Publication
(10) Pub. No.: US 2013/0086616 A1
(43) Pub. Date: Apr. 4, 2013

(54) MOBILE-CONTROLLED LIVE STREAMING SERVICE TRANSFER METHOD ON HOME NETWORK

(71) Applicants: Young-Han KIM, Seoul (KR); Ji-Won Jang, Busan (KR)

(72) Inventors: Young-Han KIM, Seoul (KR); Ji-Won Jang, Busan (KR)

(21) Appl. No.: 13/304,491

(22) Filed: Nov. 25, 2011

(30) Foreign Application Priority Data
Sep. 30, 2011 (KR) 10-2011-0099948

(51) Int. Cl. H04N 7/16

(52) U.S. Cl. 725/62

(57) ABSTRACT

This invention relates to a mobile-controlled live streaming service transfer on home network enables a user to receive live streaming services using a desired home terminal without delay time for live streaming by relaying live streaming services toward a mobile terminal, without agreement between network providers and request for signaling processing with service sources, when a mobile terminal with multiple interfaces moves to home network that belongs to domains owned by a different network provider while using live streaming services through domains owned by a single network provider and when move the currently provided live streaming services to a different home terminal.

### BACKGROUND OF THE INVENTION

1. Field of the Invention

This invention relates to a method for receiving continuous live streaming services in a home terminal in home network when a user, through a mobile terminal with multiple interfaces, receiving live streaming services (Ex. TV live broadcast, personal live broadcasting) that belong to a network provider domain A moves to home network that belongs to a network provider domain B, more particularly, to a method for enabling continuous live streaming services regardless of network providers, and also to a method for providing continuous live streaming services to several home terminals in home network using Wi-Fi regardless of network providers with no time delay for the live streaming.

2. Description of the Related Art

Service mobility technique is for supporting a mobility of services between different terminals, and this enables a different terminal to receive currently receiving services through a process of creating new services with a source providing services with a session control protocol (SIP). For example, continuous services are available, using services on TV at home and using services on a smartphone outside.

However, these protocols are available for on-demand streaming services, but it is limited to the case of real-time live streaming services or HTTP based streaming services. In these cases, a mobile terminal user should move to his home network and get live streaming services using a different home terminal through service source and signaling processing. At a time of moving live streaming services, time delay for the live streaming occurs before live streaming services move to a home terminal through a signaling processing, user satisfaction with services is influenced since a user is unable to see the desired screen during this time.

In addition, the farther the distance between the service source and the terminal is, delays appear to be even longer, and signaling for agreement between two network providers is also required in case of supporting live streaming services between different network providers.

Therefore, a method for flexibly providing receiving services to a number of home terminals is required without affecting the delay time regardless of a location of the network provider by relaying services from the mobile terminal currently used by a user.

FIG. 1 is a flowchart of the process of moving previously proposed on-demand streaming services to a different home terminal.

Referring to FIG. 1, if a user intends to move services to a different home terminal (20) while receiving on-demand streaming services from a streaming server (30) using a mobile terminal (10), a signaling between two terminals (10)(20) occurs. At this time, home terminal (20) requests to reset the services received by the current mobile terminal (10) by communicating with a streaming server (30), and requests to stop the currently receiving streaming services if the process is completed.

And, services are moved from a mobile terminal (10) to a home terminal (20) with requests settings—starts where the previous one left off.

However, it occurs that a user is unable to see the desired screen in the case of live streaming services when there is a service interruption request as above, and services are not provided with the home terminal (20) before signaling agreement between home terminal (20) and service source.

Meanwhile, these conventional on-demand streaming services of moving to a different home terminal only proposes a movement of streaming services within the same network provider domain, it is not possible to move all the on-demand and live streaming services without agreement between network providers, and the solution has not been provided at the moment.

### SUMMARY OF THE INVENTION

The present invention is conceived to solve the above-described problems. An object of the present invention is to provide a mobile-controlled live streaming service transfer method on home network, when a mobile terminal with multiple interfaces moves to home network that belongs to domains owned by a different network provider while using live streaming services through domains owned by a single network provider, and when move the currently receiving live streaming services to a different home terminal, it can, regardless of the current network provider, provide live streaming services without agreement between network providers and without signaling processing with service source by relaying live streaming services toward a mobile terminal, and enables a user to receive services using a desired home terminal without time delay for live streaming.

In order to attain the above-described object, a feature of a mobile-controlled live streaming service transfer method on home network according to the present invention is comprising the steps of: moving a mobile terminal receiving live streaming services through a network provider domain A to home network that belongs to a network provider domain B; performing a discovery process whether the above live streaming services are available by using a home terminal or not when it is selected to use live streaming series provided with a mobile terminal using a home terminal on the above home network; establishing a connection with a mobile terminal by receiving the same port number with application type from a mobile, terminal by transmitting a service search request message to a mobile terminal by the above home terminal; transmitting, in the above borne terminal, an order request message including its IP address and “R” frog to a mobile terminal: creating a service flow binding entry based on the movement request message received from the above home terminal, and performing service flow-based routing operations using a created service flow binding entry; providing live streaming services by transferring live streaming services toward the above mobile terminal to IP address of the home terminal through a service binding entry of a mobile terminal.

Desirably, it is characterized that the above network provider domain A and the above network provider domain B are different network provider domains without agreement between providers for live streaming transmission services.

In order to attain the above-described object, another feature of a mobile-controlled live streaming service transfer method on home network according to the present invention is comprising the steps of: moving a mobile terminal receiving live streaming services through a network provider domain to home network that belongs to the above network provider domain; performing a discovery process whether the above live streaming services are available by using a home terminal or not when it is selected to use live streaming services provided with a mobile terminal using a home terminal on the above home network; establishing a connection with a mobile terminal by receiving the same port number with application type from a mobile terminal by transmitting a service search request message to a mobile terminal by the above home terminal; transmitting, in the above home terminal, an order request message including its IP address and “R” frog to a mobile terminal; creating a service flow binding entry based on the movement request message received from the above home terminal, and performing service flow-based routing operations using a created service flow binding entry; providing live streaming services by transferring live streaming services toward the above mobile terminal to IP address of the home terminal through a service binding entry of a mobile terminal.

Desirably, the above discovery process comprising the steps of: detecting application which is used by a mobile terminal to receive live streaming services by the above home terminal; determining whether application mobile terminal uses can be used or not based on the detected application by the above home terminal; maintaining the application of the above mobile terminal in an operable condition if the above application is available from the above judging results.

Desirably, the establishment of a connection between the above home terminal and the mobile terminal is made using a Wi-Fi Peer-to-peer connection.

Desirably, the above service flow binding entry stores together a flag field having information to determine whether to perform a movement to the home terminal, Src IP having information about source IP address of live streaming services, Dst IP having information about destination IP address, Src Port having information about source port number, Dst Port having information about destination port number, Protocol having protocol type information, Flow ID having ID information of the relevant live streaming services, Target Dst IP having information about IP address of the home terminal.

Desirably, the step for providing live streaming services to the home terminal features providing live streaming services to the home tel through a tunnel method by adding the information on that the above mobile terminal has IP address of the home terminal as a destination IP address, and has IP address of the currently moving mobile terminal as a source address to an existing IP header in the form of new IP header.

Desirably, the step for providing live streaming services to the home terminal features providing live streaming services to the home terminal by changing previously received destination IP address and source IP address to IP address of the home terminal and IP address of the mobile terminal, respectively.

The mobile-controlled live streaming service transfer method on home network according to the present invention, as explained above, when a mobile terminal receiving live streaming services with multiple interfaces moves to a home network that belongs to different network provider domains, enables live streaming services regardless of the current network providers, provides users with more satisfactory services by reducing delay time for live streaming because live streaming services are inherited by the mobile terminal without live streaming service source and signaling exchanging processes, also can reduce signaling costs.

### THE BRIEF DESCRIPTION OF THE DRAWINGS

FIG. 1 is a flowchart of the process of moving previously proposed on-demand streaming services to a different home terminal.

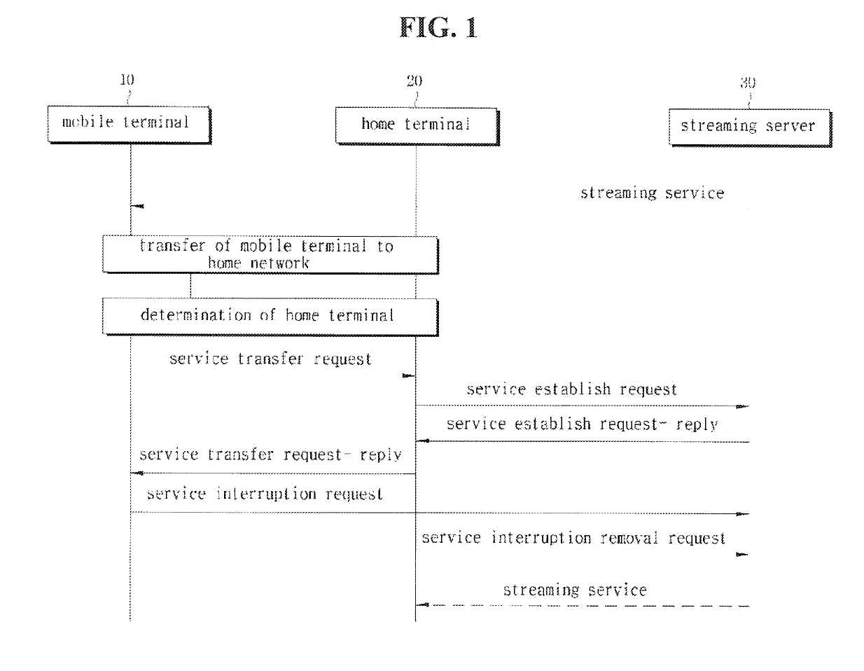

FIG. 2 is a block diagram explaining the mobile-controlled live streaming transfer on home network according to the preferred embodiments of the present invention.

FIG. 3 is a flowchart illustrating processes to transfer live streaming services to home terminal (330) in home network (300) in mobile terminal (130) according to the present invention.

FIG. 4 is a drawing illustrating the structure of service flow binding entry in the mobile terminal.

FIG. 5 is a flowchart illustrating processes of transferring on-demand streaming services for explaining mobile-controlled live streaming service transfer on home network according to the preferred embodiments of the present invention to a different home terminal.

### DESCRIPTION OF THE PREFERRED EMBODIMENT

Other objects, features and advantages of the present invention will be clarified hereinafter through detailed description on the embodiments with reference to the accompanying drawings.

Hereinafter, preferred embodiment of a mobile-controlled live streaming service transfer method on home network according to the present invention will be described in detail with reference to the accompanying drawings. However, the embodiments described below are provided to fully initiate the present invention and to fully inform the scope of the invention to one having ordinary skill in the art but are not intended to limit the scope of the present invention. One ordinarily skilled in the art can make various changes and modifications within the scope of the present invention. Therefore, the embodiments described in, the specification and structures shown on the drawings are simply the most desirable examples of the present invention, not represent every technical spirit in the present invention. Therefore, it is necessary to understand that there can be various equivalents and modifications at the point of filing.

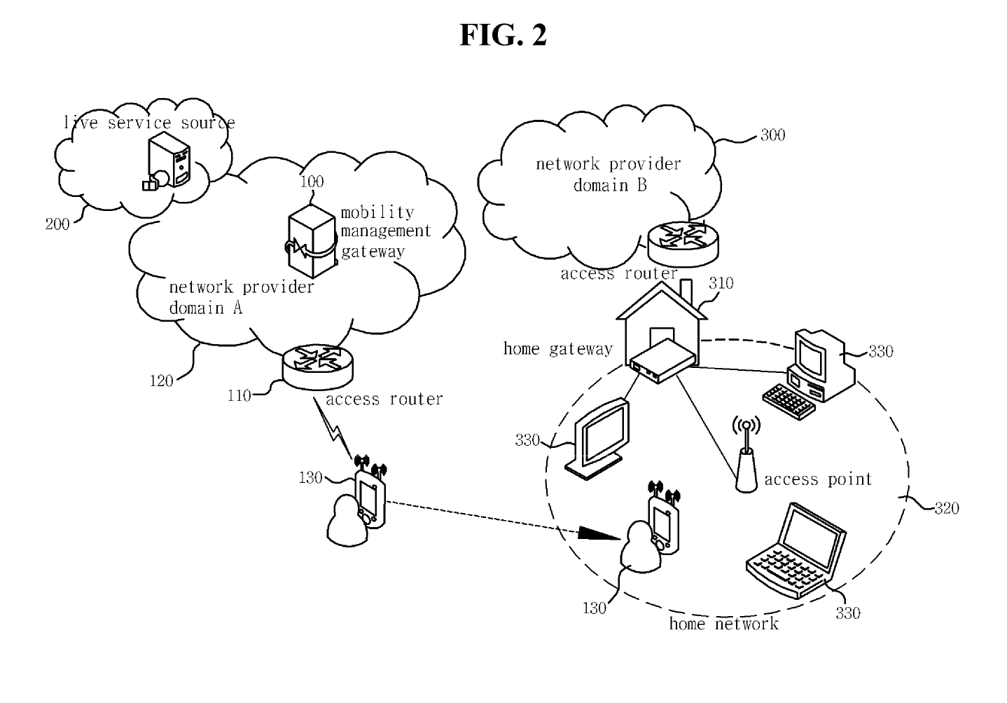

FIG. 2 is a block diagram explaining the mobile-controlled live streaming transfer on home network according to the preferred embodiments of the present invention.

Referring to FIG. 2, it shows that a mobile terminal (130), which belongs to a network provider domain A consists of a mobility management gateway (100) and an access router (110) moves to home network (320) connected to a home gateway (310) of a different network provider domain B (300) while receiving services through a live service source (200).

Here, live streaming services of the mobile terminal (130) are provided by a network provider domain A (120), and represents an environment capable of direct movement of services through the mobile terminal (130) without agreement between providers and time delay for services if a user intends to use terminals (330) within home network (320).

Hereinafter, the structure of mobile-controlled service transfer shown in FIG. 2 will be described in detail.

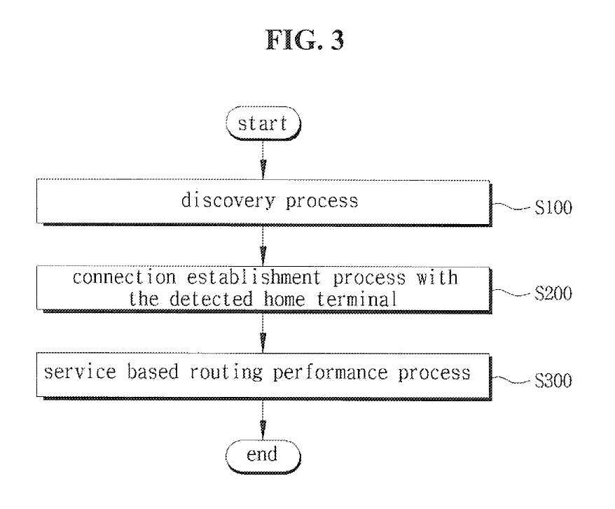

FIG. 3 is a flowchart illustrating processes to transfer live streaming services to home terminal (330) in home network (300) in mobile terminal (130) according to the present invention.

As shown in FIG. 3, as mobile terminal (130) moves to the home network (320), the mobile terminal (130) detects the home terminal (330), and discovery process of determining whether live streaming services can be moved or not is performed. At this point, it can be determined whether home terminal (330) not mobile terminal (130) can move live streaming services by detecting the mobile terminal (130) connected to the home network (320).

Namely, the above home terminal (330) determines by which application the mobile terminal (130) receives live steaming services, determines based on this whether the home terminal (330) can use application the mobile terminal uses, and prepares to execute the application of the above mobile terminal (130) in its home terminal (330). At this point, it is established that the mobile terminal (130) and the home terminal (330) use the same port number in the above discovery process.

And, upon completion of discovery process (S100) of the home terminal (330), a connection establishment process (S200) between the detected home terminal (330) and the mobile terminal (130) is made. At this point, the above the mobile terminal (130) and the home terminal (330) are connected using local wireless network such as Wi-Fi Peer-to-peer.

Upon completion of the connection establishment process (S200) between the detected home terminal (330) and the mobile terminal (130), the above mobile terminal (130) stores IP address and port number of the home terminal (330) in the cache of the mobile terminal (130), and performs service flow-based routing operations (S300) by creating service flow binding entry (400).

The above mobile terminal (130) should relay only live streaming services to the home terminal (330) since a lot of background work is done besides live streaming services.

Accordingly, service flow-based routing operations should be performed in the above mobile terminal (130). At this point, the above service flow-based routing operations classify service flows first by destination IP address, port number, source IP number and protocol type, classify live streaming services toward the mobile terminal (130) in the same way as above, and registers with service flow binding entry of the mobile terminal (130).

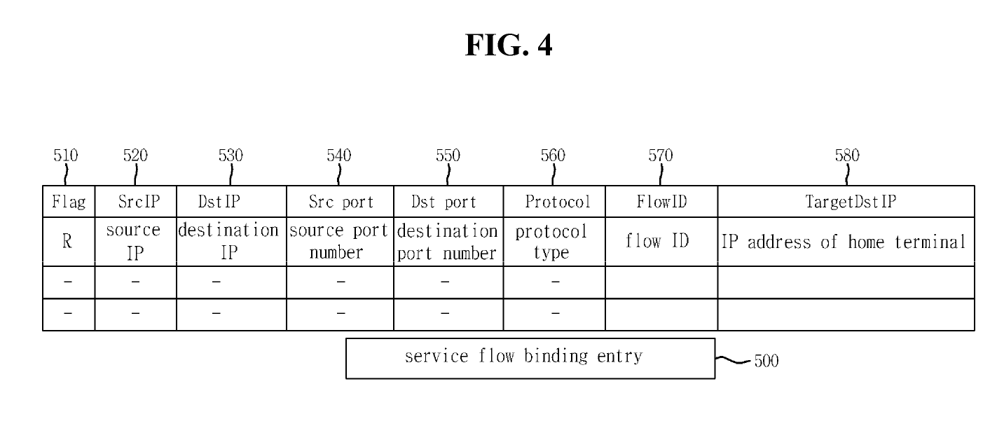

The above service flow binding entry as shown in FIG. 4 includes information about flag field (410), Src IP (420), Dst IP (430), Src Port (440), Dst Port (450), Protocol (460), Flow ID (470) and Target Dst IP (580).

At this point, the above flag field (410) is an information used to determine whether to perform the movement to the home terminal (330), the above Src IP (420) is a source IP address information of live streaming service, the above Dst IP (430) is a destination IP address information, the above Src Port (440) is a source port number information, the above Dst Port (450) is a destination port number information. And the Protocol (460) is a protocol type information, namely UDP or TCP, and the above Flow ID (470) is a ID information of the relevant live streaming services. For reference, the above ID is determined by source IP address, destination JP address, port number and protocol type of the relevant live service flow. Lastly, the above Target Dst IP (580) is a IP address information of the home terminal (330).

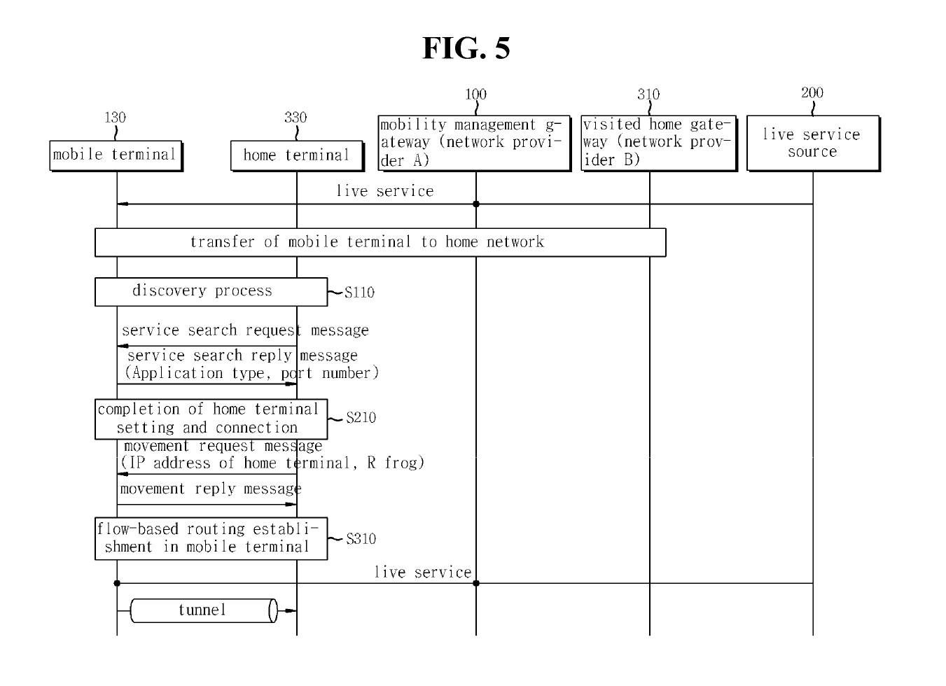

FIG. 5 is a flowchart illustrating processes of transferring on-demand streaming services for explaining mobile-controlled live streaming service transfer on home network according to the preferred embodiments of the present invention to a different home terminal.

Referring to FIG. 5, the mobile terminal (130) receives live streaming services first through a network provider domain A (120) before moving to a network provider domain B (300). And when the above mobile terminal (130) moves to home network (320) that belongs to a network provider domain B (300), it is detected to be placed on a different provider domain through a connection with home gateway (310).

At this point, if a user choose to use live streaming services the mobile terminal (130) receives by using the home terminal (330) in home network (320), a discovery process, a usability determination process whether the above live streaming services are available on the above home terminal (330) or not, is performed.

And then, the home terminal (330) establishes a connection with the mobile terminal (130) by receiving; the same port number with application type from the mobile terminal (130) by transmitting a service search request message to the mobile terminal (130).

Whereafter, the above home terminal (330) transmits an order request message to the mobile terminal (130) along with its IP address and “R” frog. Then, the mobile terminal (130) creates a service flow binding entry (400) as, shown in FIG. 4 based on the movement request message received from the home terminal (330), and performs service flow-based routing operations (S310) using a created service flow binding entry (400).

Through this, it is possible to provide live streaming services to the home terminal (330) by transferring live streaming services toward the above mobile terminal (130) to IP address of the home terminal (330) through a service binding entry of the mobile terminal (130).

On the other hand, live streaming services can be transferred to the home terminal (330) in two ways if live streaming services arrive to the mobile terminal (130) wherein the above service flow routing operations has been performed.

First, the above mobile terminal (130) provides the home terminal (330) with live streaming services by transferring to the home terminal (330) through a tunnel method with adding, in the form of new IP header, to IP header wherein IP address of the home terminal (330) and IP address of the currently moving mobile terminal (130) are established as destination IP address and source IP address, respectively.

Secondly, it provides the home terminal with live streaming services by transferring with changing an existing destination address and an existing source address to IP of the home terminal (330) and IP of the mobile terminal (130), respectively without using additional headers in the above mobile terminal.

Accordingly, when the mobile terminal (130) moves to home network that belongs to domains owned by a different network provider while using live streaming services through domains owned by a single network provider, and when transferring the currently receiving live streaming services to a different home terminal (330), users can receive services using desired home terminal (330) by relaying live streaming services toward the mobile terminal (130) without request for signaling processing with live service, sources regardless of network providers.

Even though the above explained technical spirits of the present invention are specifically described in the preferred embodiments, it is important to note that the above embodiments are just for explanation, not for a limitation on the invention. Also, it will be apparent that one having ordinary skill in the art can make various modifications and changes thereto within the scope of the present invention. Therefore, the true scope of the present invention should be defined by the technical spirits of the appended claims.

1. A mobile-controlled live streaming service transfer method on home network comprising the steps of: moving a mobile terminal receiving live streaming services through a network provider domain A to home network that belongs to a network provider domain B; performing a discovery process whether the above live streaming services are available by using a home terminal or not when it is selected to use live streaming services provided with a mobile terminal using a home terminal on the above home network; establishing a connection with a mobile terminal by receiving the same port number with application type from a mobile terminal by transmitting a service search request message to a mobile terminal by the above home terminal; transmitting, in the above home terminal, an order request message including its IP address and “R” frog to a mobile terminal; creating a service flow binding entry based on the movement request message received from the above home terminal, and performing service flow-based routing operations using a created service flow binding entry; providing live streaming services by transferring live streaming services toward the above mobile terminal to IP address of the home terminal through a service binding entry of a mobile terminal.

2. The method as claimed in claim 1, wherein the above network provider domain A and the above network provider domain B are different network provider domains without agreement between providers for live streaming transmission services.

3. A mobile-controlled live streaming service transfer method on home network comprising the steps of: comprising the steps of: moving a mobile terminal receiving live streaming services through a network provider domain to home network that belongs to the above network provider domain; performing a discovery process whether the above live streaming services are available by using a home terminal or not when it is selected to use live streaming services provided with a mobile terminal using a home terminal on the above home network; establishing a connection with a mobile terminal by receiving the same port number with application type from a mobile terminal by transmitting a service search request message to a mobile terminal by the above home terminal; transmitting, in the above home terminal, an order request message including its IP address and “R” frog to a mobile terminal; creating a service flow binding entry based on the movement request message received from the above home terminal, and performing service flow-based routing operations using a created service flow binding entry; providing live streaming services by transferring live streaming services toward the above mobile terminal to IP address of the home terminal through a service binding entry of a mobile terminal.

4. The method as claimed in claim 1, wherein the above discovery process comprising the steps of: detecting application which is used by a mobile terminal to receive live streaming services by the above home terminal;
determining whether application mobile terminal uses can be used or not based on the detected application by the above home terminal; maintaining the application of the above mobile terminal in an operable condition if the above application is available from the above judging results.

5. The method as claimed in claim 1, wherein the establishment of a connection between the above home terminal and the mobile terminal is made through local area network including Wi-Fi Peer-to-peer connection.

6. The method as claimed in claim 1, wherein the above service flow binding entry stores together a flag field having information to determine whether to perform a movement to the home terminal, Src IP having information about source IP address of live streaming services, Dst IP having information about destination IP address, Src Port having information about source port number, Dst Port having information about destination port number, Protocol having protocol type information, Flow ID having ID information of the relevant live streaming services, Target Dst IP having information about IP address of the home terminal.

7. The method as claimed in claim 1, wherein the step for providing live streaming services to the home terminal features providing live streaming services to the home terminal through a tunnel method with adding, in the form of new IP header, to IP header wherein IP address of the home terminal and IP address of the currently moving mobile terminal are established as destination IP address and source IP address, respectively.

8. The method as claimed in claim 1, wherein the step for providing live streaming services to the home terminal features providing live streaming services to the home terminal by changing previously received destination IP address and source IP address to IP address of the home terminal and IP address of the mobile terminal, respectively.

9. The method as claimed in claim 3, wherein the above discovery process comprising the steps of: detecting application which is used by a mobile terminal to receive live streaming services by the above home terminal;
determining whether application mobile terminal uses can be used or not based on the detected application by the above home terminal; maintaining the application of the above mobile terminal in an operable condition if the above application is available from the above judging results.

10. The method as claimed in claim 3, wherein the establishment of a connection between the above home terminal and the mobile terminal is made through local area network including Wi-Fi Peer-to-peer connection.

11. The method as claimed in claim 3, wherein the above service flow binding entry stores together a flag field having information to determine whether to perform a movement to the home terminal, Src IP having information about source IP address of live streaming services, Dst IP having information about destination IP address, Src Port having information about source port number, Dst Port having information about destination port number, Protocol having protocol type information, Flow ID having ID information of the relevant live streaming services, Target Dst IP having information about IP address of the home terminal.

12. The method as claimed in claim 3, wherein the step for providing live streaming services to the home terminal features providing live streaming services to the home terminal through a tunnel method with adding, in the form of new IP header, to IP header wherein IP address of the home terminal and IP address of the currently moving mobile terminal are established as destination IP address and source IP address, respectively.

13. The method as claimed in claim 3, wherein the step for providing live streaming services to the home terminal features providing live streaming services to the home terminal by changing previously received destination IP address and source IP address to IP address of the home terminal and IP address of the mobile terminal, respectively.
